(19) United States
(12) Patent Application Publication
(10) Pub. No.: US 2026/0003586 A1
(43) Pub. Date: Jan. 1, 2026

(54) SYSTEM AND METHOD FOR HEADLESS COMPONENT INTEGRATION

(71) Applicant: Wix.com Ltd., Tel Aviv (IL)

(72) Inventor: Yoav ABRAHAMI, Tel Aviv (IL)

(21) Appl. No.: 19/250,719

(22) Filed: Jun. 26, 2025

Related U.S. Application Data
(60) Provisional application No. 63/664,740, filed on Jun. 27, 2024.

(51) Int. Cl. G06F 8/38; G06Q 30/0601

(52) U.S. Cl. CPC G06F 8/38; G06Q 30/0643

(57) ABSTRACT

A system for integrating design to code components in software development includes at least one processor; a design to code (D2C) tool running on the processor configured to enable creation of D2C projects comprising user interface designs based on D2C components having associated D2C contracts, where the D2C contracts include at least instructions for data, interactive elements and at least one aspect contract for D2C components specifying requirements for user interface designs; and a D2C contract handler running on the at least one processor configured to create and manage the D2C contracts

### CROSS REFERENCE TO RELATED APPLICATIONS

This application claims priority from U.S. provisional patent application 63/664,740, filed Jun. 27, 2024, which is incorporated herein by reference.

### FIELD OF THE INVENTION

The present invention relates generally to user interface design and integration in software development and to facilitating the design and integration of user interfaces with headless components in particular.

### BACKGROUND OF THE INVENTION

An application (app) design typically combines a user interface and user experience (UX). User interface design tends to focus on the overall style of the app, like colors, fonts, and the general look and feel.

The user experience tends to focus on functionality and usability. User interface design typically focuses on what designers might need to do to ensure the interface has the correct elements that make it easy to access, understand, and use and facilitate those actions. User interface design combines the concepts from interaction design, visual design, and information architecture.

The field of software development has seen significant advancements in recent years, particularly in the realm of user interface (UI) design and implementation. As digital products become increasingly complex, the need for efficient and flexible development processes has grown.

In traditional software development workflows, designers create visual mockups of user interfaces using specialized design tools. These designs are then handed off to developers who translate them into functional code. This process often involves multiple iterations and can lead to discrepancies between the intended design and the final implemented product. As applications grow in complexity and need to support multiple platforms and devices, the challenges of maintaining consistency and efficiency in the design-to-code process have become more pronounced.

Design systems have emerged as a solution to promote consistency and reusability in user interface (UI) development. These systems typically consist of a collection of reusable components, guidelines, and standards that ensure a cohesive look and feel across an application or suite of products. However, integrating design systems with the actual implementation of user interfaces remains a challenge for many development teams.

The concept of component-based development has also gained popularity, allowing developers to create modular, reusable pieces of functionality. This approach aligns well with modern frontend frameworks and libraries, enabling more efficient development and maintenance of complex applications.

### SUMMARY OF THE PRESENT INVENTION

There is therefore provided, in accordance with a preferred embodiment of the present invention, a design to code (D2C) system for component integration in software development. The system includes at least one processor, a design to code (D2C) tool, and a D2C contract handler. The design to code (D2C) tool running on the processor is configured to enable creation of D2C projects including user interface designs based on D2C components having associated D2C contracts, where the D2C contracts include at least instructions for D2C component data, interactive elements and at least one aspect contract for the D2C components specifying requirements for the user interface designs. The D2C contract handler running on the at least one processor is configured to create and manage the D2C contracts.

Moreover, in accordance with a preferred embodiment of the present invention, the system further includes a contract fulfilling integrated development environment (IDE) configured to enable development of code for the D2C components in accordance with the D2C contracts.

Further, in accordance with a preferred embodiment of the present invention, the D2C tool further includes a design editor, a contract fulfiller, and a publisher. The design editor is configured to enable creation of the user interface designs. The contract fulfiller is configured to verify compatibility of the user interface designs with the D2C contracts. The publisher is configured to publish finalized user interface designs.

Still further, in accordance with a preferred embodiment of the present invention, the D2C contract handler further includes a contract creator, a contract editor, a contract updater, a contract verifier, and a D2C component tester. The contract creator is configured to create new D2C contracts. The contract editor is configured to enable editing of existing D2C contracts. The contract updater is configured to update derived designs when a base design is modified. The contract verifier is configured to verify compatibility between user interface designs and associated D2C components. The D2C component tester is to determine if a D2C component is behaving as defined by its D2C contract.

Additionally, in accordance with a preferred embodiment of the present invention, the system further includes a large language model (LLM) coordinator in communication with a large language model (LLM) configured to generate content for D2C contracts according to at least one of textual descriptions, design notes, and drawings, provide suggestions for user interface designs and design stories based on existing D2C contracts, and provide editing assistance for the D2C tool and the contract fulfilling IDE.

Moreover, in accordance with a preferred embodiment of the present invention, the at least one aspect contract consists of provisions for at least one of business intelligence events, multilingual support, A/B testing, accessibility limitations, and responsive breakpoints.

Further, in accordance with a preferred embodiment of the present invention, the system further includes a third-party application integrator configured to interface with external services to the D2C system and extend functionality of the D2C components to the external services in accordance with the D2C contracts.

Still further, in accordance with a preferred embodiment of the present invention, the D2C contracts further include instructions to generate design stories, where the design stories describe how a user interface should function and interact with the D2C components, create derived design examples for a design story by copying a main design and injecting content from the design stories, and use the design stories to generate tests for the D2C components by capturing D2C component output and test case.

Additionally, in accordance with a preferred embodiment of the present invention, the system further includes at least one repository configured to store at least one of data types, front-end components, back-end components, D2C contracts, aspect contracts, contract templates, prompt templates and knowledge base data.

Moreover, in accordance with a preferred embodiment of the present invention, the LLM coordinator includes a prompt generator, an AI (artificial intelligence) output evaluator, and an AI (artificial intelligence) learning optimizer. The prompt generator is configured to analyze a current state of a D2C project, select a prompt template accordingly and to fill in missing information required for the prompt template. The AI (artificial intelligence) output evaluator is configured to assess a response from the LLM for relevance, accuracy, and adherence to D2C contract specifications. The AI (artificial intelligence) learning optimizer is to analyze interactions, outcomes, and feedback with the LLM to refine system performance of the D2C system over time.

There is therefore provided, in accordance with a preferred embodiment of the present invention, a computer-implemented method for a design to code (D2C) system for component integration in software development, enabling creation of D2C projects including user interface designs based on D2C components having associated D2C contracts using at least one processor, where the D2C contracts include instructions for at least D2C component data, interactive elements and at least one aspect contract for the D2C components specifying requirements for the user interface designs, and creating and managing the D2C contracts.

Moreover, in accordance with a preferred embodiment of the present invention, the method further includes enabling development of code for the D2C components in accordance with the D2C contracts within an integrated development environment.

Further, in accordance with a preferred embodiment of the present invention, the method further includes enabling creation of user interface designs via a design editor, verifying compatibility of the user interface designs with the D2C contracts, and publishing finalized user interface designs.

Still further, in accordance with a preferred embodiment of the present invention, the method further includes creating new D2C contracts, enabling editing of existing D2C contracts, updating derived designs automatically when a base design is modified, verifying compatibility between user interface designs and associated D2C components, and determining if a D2C component is behaving as defined by its D2C contract.

Additionally, in accordance with a preferred embodiment of the present invention, the method further includes prompting a large language model (LLM) to generate content for D2C contracts according to at least one of textual descriptions, design notes, and drawings, provide suggestions for user interface designs based on existing D2C contracts, and provide editing assistance for design and contract fulfillment.

Moreover, in accordance with a preferred embodiment of the present invention, the at least one aspect contract consists of at least one of business intelligence events, multilingual support, A/B testing, accessibility limitations, and responsive breakpoints.

Further, in accordance with a preferred embodiment of the present invention, the method further includes interfacing with external services to the D2C system and extending functionality of the D2C components in accordance with the D2C contracts.

Still further, in accordance with a preferred embodiment of the present invention, the D2C contracts further enable generating design stories that describe how a user interface should function and interact with the D2C components, creating derived design examples for a design story by copying a main design and injecting content from the design stories, and generating tests for the D2C components by capturing D2C component output and test cases.

Additionally, in accordance with a preferred embodiment of the present invention, the method further includes storing at least one of data types, front-end components, back-end components, D2C contracts, aspect contracts, contract templates, prompts and knowledge base data in a repository.

Moreover, in accordance with a preferred embodiment of the present invention, the prompting an LLM includes analyzing a current state of a D2C project, selecting a prompt template according to context and task as determined by the analyzing a current state, identifying and filling in any missing information required for the prompt template, assessing a response from the LLM for relevance, accuracy, and adherence to D2C contract specifications, and analyzing interactions, outcomes, and feedback with the LLM to refine system performance of the D2C system over time.

There is therefore provided, in accordance with a preferred embodiment of the present invention, a computer-implemented method including the steps of: providing at least one processor, configuring a design to code (D2C) tool (40) to run on the processor to enable creation of D2C projects comprising user interface designs based on D2C components (5), and configuring a D2C contract handler (60) to run on the at least one processor to create and manage the D2C contracts (11). The D2C components (5) include a frontend (12), defining the presentation layer of a user interface, a backend (14), defining the business logic of the user interface, and an interface configured to manage interaction between the frontend (12) and the backend (14). The D2C contracts (11) include instructions for data,, interactive elements and at least one aspect contract for the D2C components specifying requirements for user interface designs. The D2C contract specifies requirements for the D2C components (5) data inputs, event outputs, and design element specifications.

There is therefore provided, in accordance with a preferred embodiment of the present invention, a system for artificial intelligence (AI) powered verification and optimization of design-to-code (D2C) component integration. The system includes at least one processor, at least one repository, an AI contract verifier, and an AI learning optimizer. At least one repository is configured to store D2C contracts and user interface (UI) designs, where a D2C contract specifies requirements for a corresponding UI design. The AI contract verifier is configured to be executed by the at least one processor to analyze a UI design and its associated D2C contract to determine a compatibility level between them and generate a verification output based on at least one of the determined compatibility level, the verification output including at least one of a compatibility report, a contract violation alert, or a design optimization suggestion. The AI learning optimizer is configured to be executed by the at least one processor to collect interaction data including user feedback related to AI-generated content within the system, analyze the interaction data to identify patterns correlated with system performance, and refine at least one operational aspect of the system according to the identified patterns to improve future performance of the system.

There is therefore provided, in accordance with a preferred embodiment of the present invention, a design to code (D2C) system for component integration. The system includes at least one processor and a large language model (LLM) coordinator. The LLM coordinator is in communication with a LLM and is configured to be executed by the at least one processor to selectively perform receiving an existing D2C contract as an input, and in response, generating a suggested user interface (UI) design and associated code that complies with the existing D2C contract, and receiving a UI design and associated code as inputs, and in response, generating a suggested D2C contract that corresponds to the received UI design and associated code.

Moreover, in accordance with a preferred embodiment of the present invention, the LLM coordinator includes a prompt generator, an Al output evaluator, and an integration module. The prompt generator is to determine at least one of the existing D2C contract and UI design and associated code and to retrieve and update a prompt template from at least one repository accordingly to create a prompt to the LLM. The AI output evaluator is to evaluate a response from the LLM. The integration module is to provide the suggested user interface (UI) design and the suggested D2C contract accordingly.

There is therefore provided, in accordance with a preferred embodiment of the present invention, a computer-implemented method for an iterative design-to-code (D2C) contract creation process, including creating, using at least one processor, an initial D2C contract based on an incomplete user interface (UI) design, where the initial D2C contract is based on initial intent only by specifying an interactive element while omitting a specific type for the interactive element, associating a tag with the initial D2C contract, where the tag indicates an intent to update the initial D2C contract at a later stage, and subsequently, enabling the editing of the initial D2C contract to specify the omitted type for the interactive element, thereby creating an updated and complete D2C contract for the incomplete UI design.

### BRIEF DESCRIPTION OF THE DRA WINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

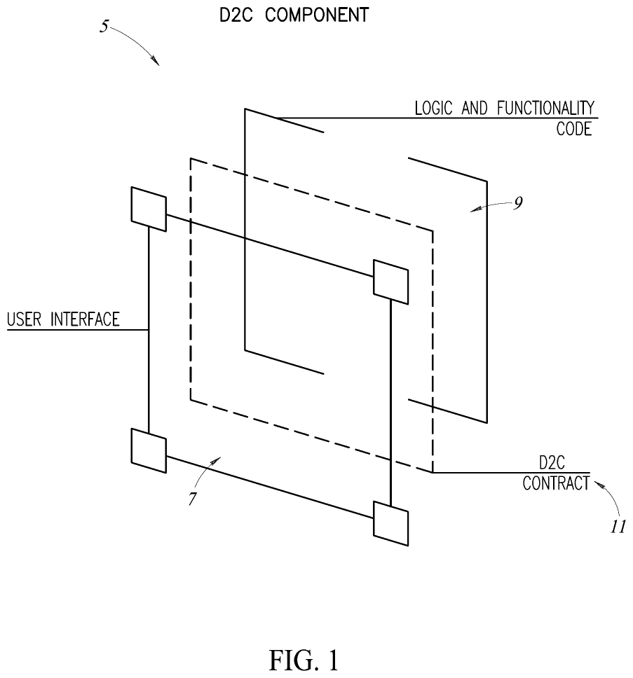

FIG. 1 is a schematic illustration of a D2C (design to code) component; constructed and operative in accordance with the present invention;

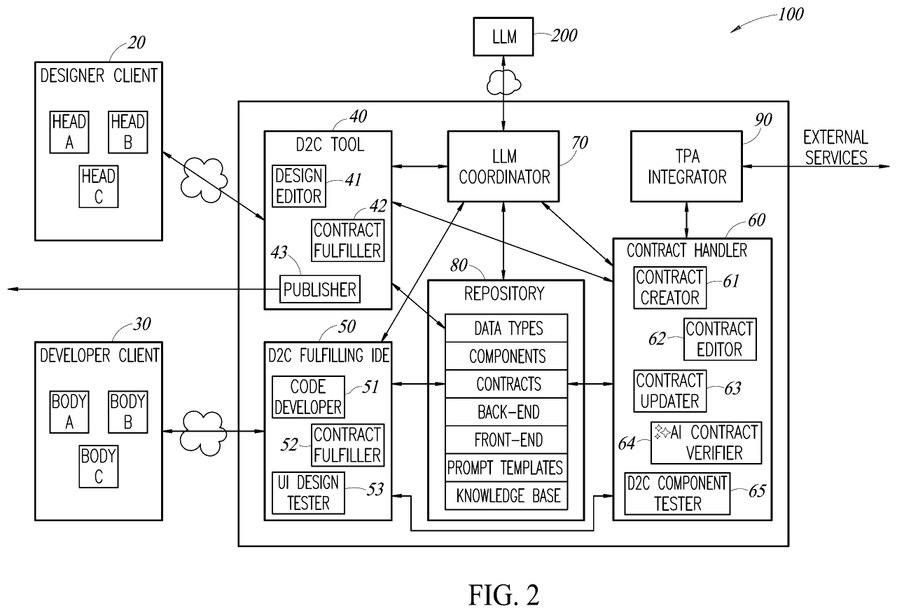

FIG. 2 illustrates a system diagram of a design to code (D2C) system, constructed and operative in accordance with the present invention;

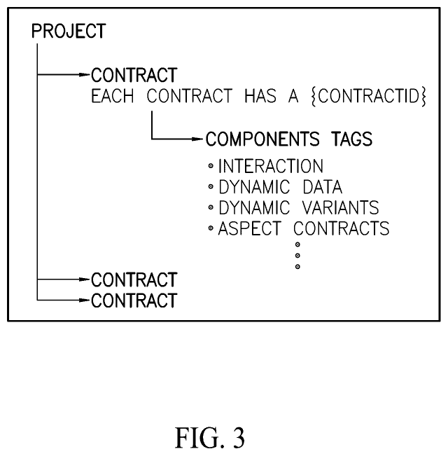

FIG. 3 is a block diagram showing the structure of a project containing D2C contracts in a D2C system, constructed and operative in accordance with the present invention;

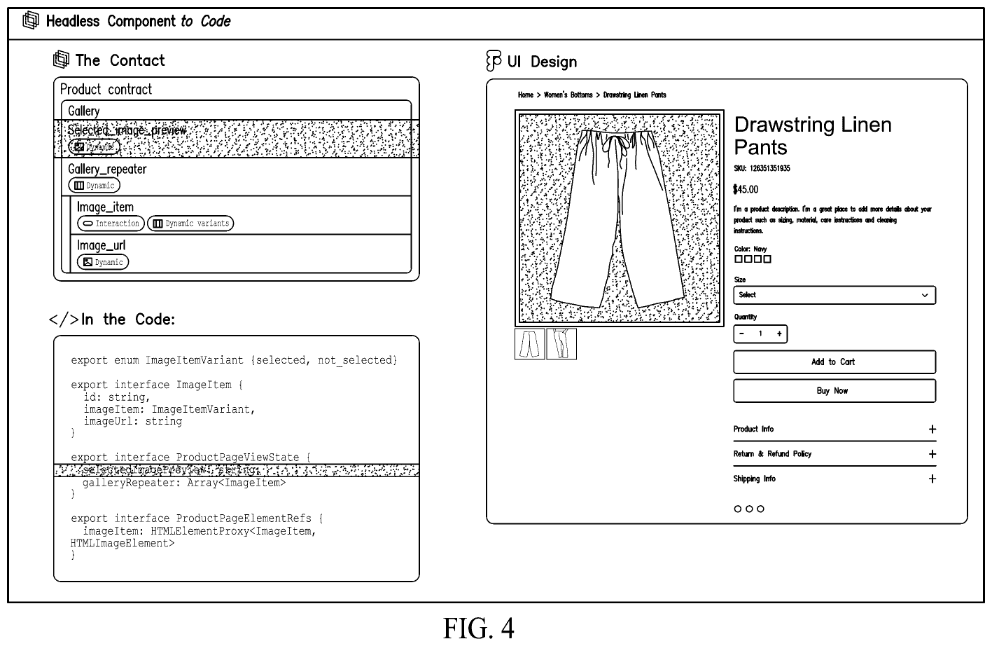

FIG. 4 showing the relationship between UI, contract and code for an e-shop selling drawstring linen pants, constructed and operative in accordance with the present invention;

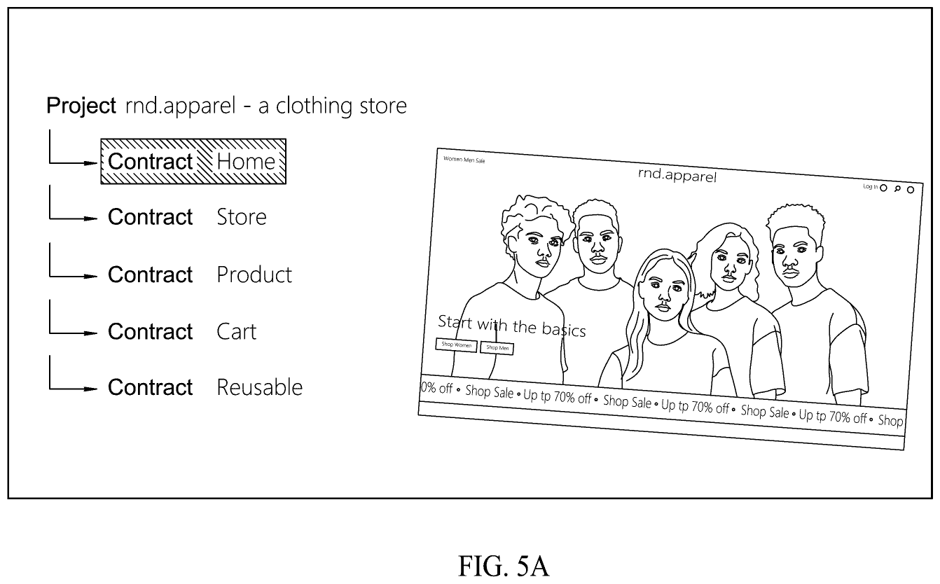

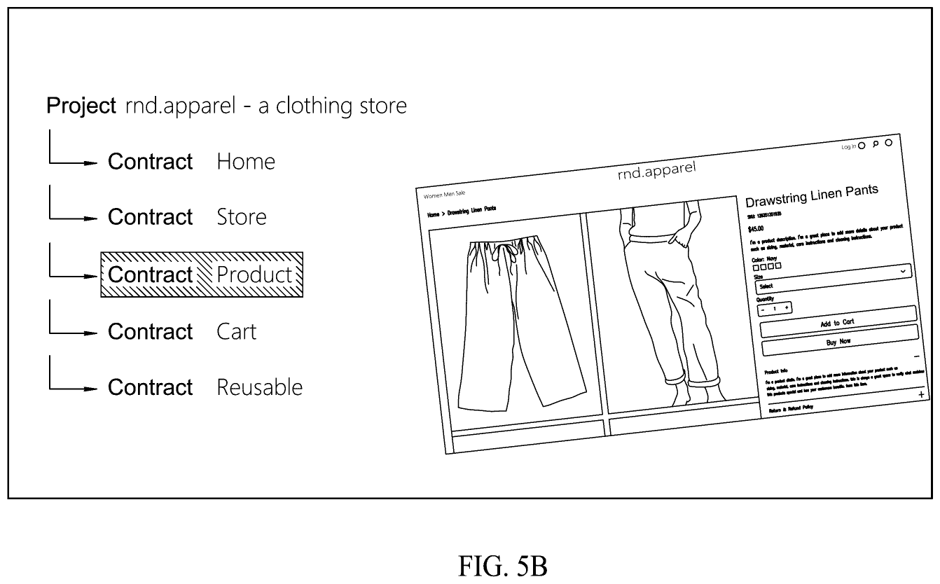

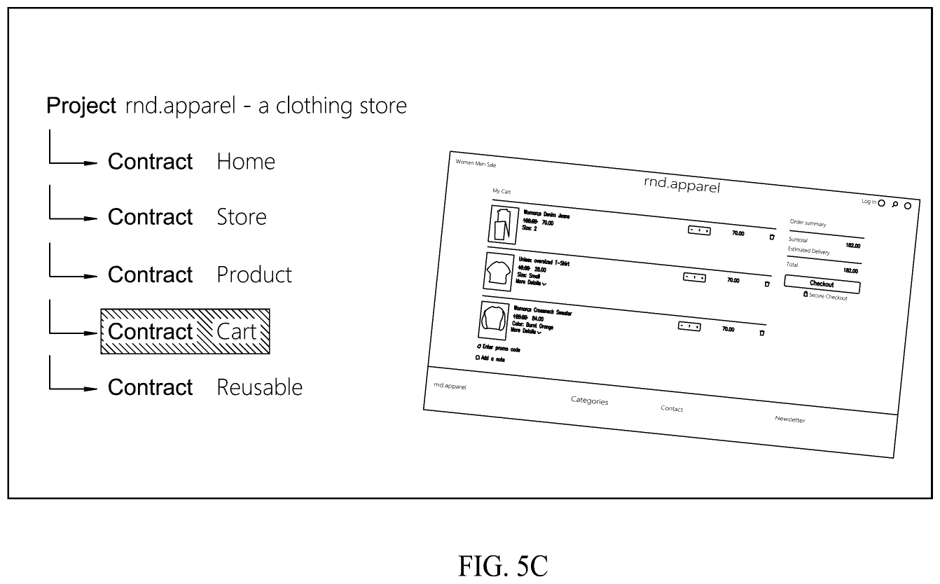

FIGS. 5A, 5B and 5C are schematic illustrations showing the structure of a project for a clothing store application, constructed and operative in accordance with the present invention;

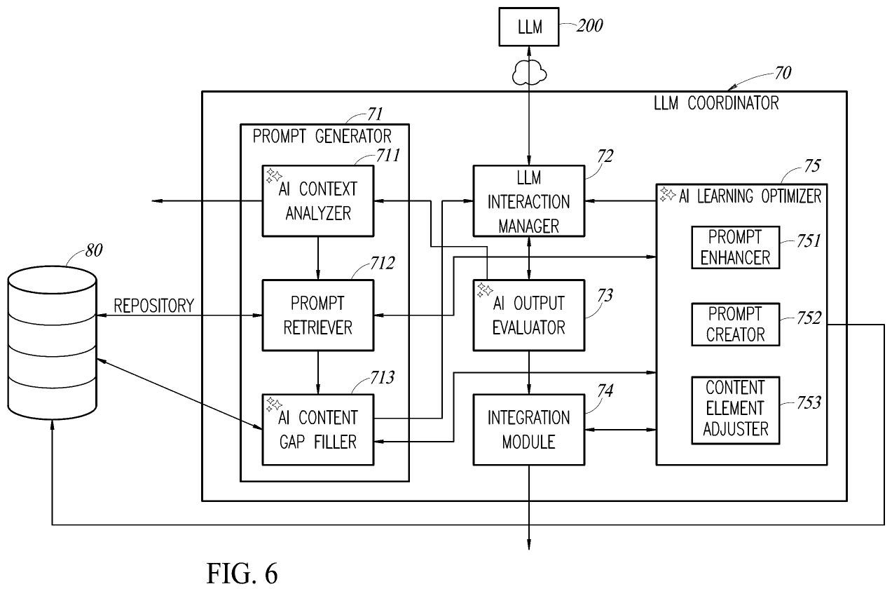

FIG. 6 is a schematic illustration of the elements of the LLM coordinator of FIG. 2, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that existing solutions for bridging the gap between user interface (UI) design and functional code implementation in software development are inadequate. The current design-to-code process often involves inefficient and error-prone manual steps, leading to misalignments between the original design intent and the final product. Traditional workflows require designers to export their UI designs to generated code, which then needs extensive manual modification to add actions, interactions, animations, and data bindings. This approach is limited by the capabilities of available design system plugins and typically results in generated code that only includes design aspects, lacking the necessary functional bindings.

Applicant has also realized that subsequent design updates necessitate re-exporting and manually merging new code with the existing codebase, a cumbersome and error-prone process. These limitations highlight the need for an improved method and system that can streamline the design-to-code workflow, enhance collaboration between designers and developers, and reduce the time and effort required to bring a design concept to fruition.

One notable approach that has gained traction is the adoption of headless architecture, which separates the frontend presentation layer from the backend business logic of a UI component. This separation allows for greater flexibility in developing and updating user interfaces without affecting the underlying functionality and further enhances collaboration between designers and developers.

An example of a headless component implementation may be in a website building system where the frontend is the user interface which is decoupled from the website's backend (business logic). Therefore, the functionality and logic of the component are separated from its presentation or styling. The elements typically communicate via an application programming interface (API). It will be appreciated that the API serves as a structured communication layer between the frontend and backend. This API defines specific endpoints, data formats, and protocols that enable the exchange of information and the triggering of actions. The API may utilize RESTful principles, GraphQL, or other suitable architectural styles to ensure efficient and scalable communication. It will be appreciated that data requests may originate from the frontend based on user interactions or application logic. These requests are formatted according to the API specifications and transmitted to the backend. The backend processes the requests, retrieves or manipulates the necessary data, and returns a response to the frontend, again formatted according to the API. The front end then renders the data in the user interface.

A typical workflow using headless architecture may be the design of a new UI using a design system such as Figma, commercially available from Figma.Inc. The UI is then exported to generated code (the coding style and quality of generated code may be determined by multiple design system plug-ins). The generated code only includes design and no binding of actions, activities, or data. The developer must then manually change the generated code by adding actions, interactions, data bindings etc.

Applicant has realized that the above-mentioned inadequacies may be solved using a form of design to code architecture that encapsulates logic and functionality separate from the user interface that also includes a type of contract or agreement between the frontend and backend that specifies the requirements for the user interface, including data inputs, event outputs, design element specifications and design variants. The contract may serve as a common language and reference point ensuring that all relevant parties are aligned. The architecture may also include a design tool which guides designers in creating user interface designs using D2C components based on a design to code (D2C) contract. This approach may also enable the generation of UI designs and design stories constrained by the D2C contract, streamlining the design to code process with the ability to check compatibility with contracts and to test UI designs. It will be appreciated that the API may provide implementation of the D2C contract between frontend and backend elements and the D2C contract may provide the meta data that defines their relationships as described in more detail herein below. It will be further appreciated that different APIs may be used to implement the same contract.

Thus, the D2C contract may serve as a formal specification of the interface between the front end and backend of a design to code (D2C) project. It may be considered a data structure that defines the data types, formats, and constraints that must be adhered to by both the frontend and backend. This formal specification ensures consistency, compatibility, and predictability in the interaction between these components.

It will be appreciated that D2C components may incorporate two types of D2C contracts: one for information from a “parent” component and another for the UI contract, allowing for more complex and hierarchical component structures.

Furthermore, such architecture could harness artificial intelligence capabilities via prompts to known large language models (LLMs) in order to provide editing assistance to designers using the design tool and to automate contract creation and updating including recommendations. As discussed herein below prompts may be hard coded by designers, templated or created based on system feedback and activity. It will also be appreciated that once given a contract, the LLM may also write the code that implements the logic, enabling the designer to fully drive the application development end to end by creating design, creating contracts, and generating code based on the contract.

It will be appreciated that such design to code architecture may broaden the horizons for omnichannel sales strategies, empowering marketing teams to make website adjustments without relying on a development team, thus offering limitless opportunities in sales channel management. It may also enhance customer experience since the customer journey unfolds on the front end, and having control over the presentation layer enables retailers to refine and customize the online shopping experience, which, coupled with swift web performance, boosts conversion rates, and elevates revenue. It may enable different teams working on the same product to deploy different sections of the UI independently and may enable the ability to build large systems without being tied to a single library.

A key advantage to this form of architecture is its ability to ensure swift loading times for eCommerce sites, a critical factor affecting search engine optimization (SEO), user experience (UX), and conversion rates saving on computational power. It may also give businesses the agility and adaptability required to thrive in the highly competitive eCommerce landscape by facilitating the integration of competitive solutions for an optimized tech stack and by offering scalable solutions, which support multi-store functionality and auto-scaling to future-proof businesses.

The architecture may also produce reduced time-to-market for new features, which can be developed, tested, and deployed independently without affecting the overall system as well as isolate bug fixes that ensure system integrity and allow for independent updates.

The modularity of the system design may also simplify the onboarding process for new developers by dividing the system into manageable parts, allowing for independent development, deployment, and scaling of services.

These attributes highlight the design to code architecture's comprehensive benefits, from enhancing frontend flexibility to offering strategic advantages in the competitive eCommerce space and also providing efficient use of associated computer systems by saving an on memory and computer resources by not having to reprogram each edit to a front end component thus also saving on developer time. The efficiency of the workflow thus provides reduced processing power for the hardware elements involved.

Reference is made to FIG. 1 which illustrates a design to code (D2C) component 5 including an associated D2C contract 11 according to an embodiment of the present invention. As is illustrated, D2C component 5 may be a data structure comprising a front end or header (7) which may be used by a designer using a design to code platform or tool to create his application, a backend or body (9) which is used by the developer in a contract fulfilling integrated development environment (IDE). D2C contract 11 may define the bridge between the logic of backend 14 and the user interface design (frontend 12), ensuring at least that the design meets the functional requirements of the headless component while allowing for flexibility in its implementation. D2C contracts are discussed in more detail herein below. It will be appreciated that the different elements may communicate via an API as described herein above.

Reference is now made to FIG. 2 which illustrates a design to code (D2C) system 100 for implementing D2C projects with design to code (D2C) components having associated D2C contracts in accordance with an embodiment of the present invention. System 100 may comprise a design to code (D2C) tool 40, a contract fulfilling IDE 50, a D2C contract handler 60, an LLM coordinator 70, a repository 80 and a third party application (TPA) integrator 90. D2C tool 40 may be in communication with a designer client 20 and D2C fulfilling IDE 50 may be in communication with a developer client 30. LLM coordinator 70 may be in communication with LLM 200 as described in more detail herein below.

It will be appreciated that some of the inventive elements of system 100 may also be AI (artificial intelligence) agents. An AI agent is a software-implemented computational entity configured to autonomously perceive input data from its environment (including digital, physical, or simulated domains), process said data using one or more machine learning, rule-based, statistical, or symbolic reasoning techniques, and execute goal-directed actions or generate outputs in response to said data.

The AI agent may operate continuously or in discrete instances, may learn from historical or real-time inputs, and may update its internal models or policies dynamically. The agent can be embodied in standalone software, embedded systems, distributed cloud environments, or hardware-integrated systems, and may include components such as inference engines, training subsystems, decision-making modules, and interaction interfaces (e.g., via natural language, API, sensors, or actuators).

Any AI models used by AI agents may be run on the underlying website building system (WBS) servers, external servers (or providers) or locally on clients 20 and 30 as part of specific client code, the browser used, the operating system or integrated into hardware or as any combination.

It will be appreciated that D2C tool 40 may comprise elements which may be integrated with any UI design system such as Figma. D2C fulfilling IDE 50 may comprise elements integrated with any commercially available IDE.

A UI designer may use D2C tool 40 to create his interface on designer client 20 using “heads” (A, B and C) of D2C components and a developer may provide the “body” or code (A, B and C) for the “body” components on developer client 30 using D2C using D2C fulfilling IDE 50. The instructions pertaining to the use of a D2C component may be according to a D2C contract between the two as described in more detail herein below.

It will be appreciated that D2C components may also include interactive components such as a counter with a displayed number and increment/decrement buttons, allowing for D2C contract updates to implement specific animations or behaviors.

D2C tool 40 may further comprise a design editor 41, a contract fulfiller 42 and a publisher 43. A designer may use design editor 41 to design his user interface. Contract fulfiller 42 may verify that any design is compatible with associated D2C contracts as described in more detail herein below. Publisher 43 may publish a finished UI design.

D2C fulfilling IDE may further comprise a code developer 51, a contract fulfiller 52 and a UI design tester 53. A developer may use code developer 51 to write his code and create UI designs accordingly. Contract fulfiller 52 may verify that any code is compatible with associated D2C contracts. UI design tester 53 may evaluate UI designs before publication as discussed in more detail herein below.

It will be appreciated that contract fulfillers 42 and 52 may automatically verify that the front end and backend code adhere to the D2C contract. Any deviations from the contract are flagged as errors, preventing inconsistencies and ensuring compatibility. Contract fulfillers 42 and 52 may parse any D2C contract specifications, analyze the current UI design and/or code and extract key requirements from the pertinent contract. They may then categorize any requirements such as data inputs, event outputs, design elements etc. It will be appreciated that contract fulfillers 42 and 52 may analyze the UI design using algorithms known in the art design analysis such as those described in U.S. Pat. No. 9,747,258 entitled “System And Method for the Creation and Use of Visually-Diverse High-Quality Dynamic Layouts”, issued Aug. 29, 2017, incorporated herein by reference and assigned to the common assignee of the current invention. For code based designs, contract fulfillers 42 and 52 may use static code analysis.

Contract fulfillers 42 and 52 may then compare extracted design features against the contract specifications. In some embodiments, contract fulfillers 42 and 52 may use LLM 200 for complex comparisons. In this scenario, contract fulfillers 42 and 52 may instruct LLM coordinator 70 accordingly. Finally, they may identify any mismatches between design and contract specifications and generate a compatibility report accordingly. If the resulting report is unsatisfactory according to preset levels, contract fulfillers 42 and 52 may flag the designer or developer accordingly.

D2C contract handler 60 may manage all functionality concerning the creation, updating and validation of D2C contracts. Contract handler 60 may comprise a contract creator 61, a contract editor 62, a contract updater 63, an AI contract verifier 64 and a D2C component tester 65.

In an alternative embodiment, system 100 may also allow for design and code changes that do not affect the D2C contract in order to provide more transparency to the developer.

Repository 80 may store data types, “heads” i.e., front end 7 and “bodies” i.e., back end 9 of D2C components and associated contracts and aspect contracts, contract templates and other elements pertinent to UI design. It may further store knowledge based information relevant to system 100 and prompt templates as described in more detail herein below.

In alternative embodiments, repository 80 may comprise multiple different dedicated repositories or databases.

It will be appreciated that system 100 may be implemented in or integrated with different types of visual design and editing systems such as website building systems and design platforms such as Figma, Canva (commercially available from Canva Inc.) and other UI/UX design platforms in order to enhance their capabilities.

As discussed herein above, a D2C contract may specify requirements for the D2C components to be used to create a user interface, including data inputs, event outputs, and design element specifications. It may define the structure and properties of components like line items and cart view states, detailing fields such as id, picture, title, price, quantity, currency, total, delivery information, and promotional features. A single D2C contract may manage multiple functional front-ends with a single back-end. A single design project may comprise multiple D2C components and therefore multiple D2C contracts. A single design may also have a many to many topology i.e., many designs having implementations all using the same D2C contract.

The D2C contract may further support aspect or subcontracts for implementing provisions for additional functionalities, allowing designers to incorporate features like business intelligence events, multilingual support, A/B testing, accessibility (Ally) and auto-testing kits directly into the design as discussed in more detail herein below.

Furthermore, the D2C contract may also capture UI designer intent for a design before a design is finalized as is described in more detail herein below.

It will be appreciated that by defining the data structure and interface elements, the D2C contract ensures compatibility between the visual design and the underlying D2C component functionality. The D2C contract provides a stable and well-defined interface that allows the frontend and backend to evolve independently. Changes to the frontend or backend can be made without breaking the integration, as long as they remain compliant with the contract. This facilitates rapid iteration, experimentation, and continuous improvement of the user interface.

As discussed herein above, this approach enables direct publication of the user interface design as a functional component upon successful verification, reducing the need for manual code modifications and improving the efficiency of the design-to-implementation workflow.

Reference is now made to FIG. 3 which illustrates a project having multiple D2C contracts having tags. A single D2C contract may have a unique ID, interaction tags, dynamic data tags, dynamic variant tags and single or multiple aspect contracts. The interaction tags may enable end users to perform actions, make selections, and control various aspects of the application (such as buttons and input fields). The dynamic data tags may define the data and schema for a D2C component which may be information that is continuously updated or changed based on user interactions, system processes or external sources (such as item and price). The dynamic variant tags may enable conditional designs for different scenarios and enable the code to dynamically instruct which variant to display (such as open/close, gallery type, show selected, item type, physical vs virtual item etc.). It will be appreciated that the dynamic variant tags may also be used to implement (for example) A/B testing scenarios for use by analytic tools.

It will also be appreciated that tags in general may also contain indication of an intent by both designers and developers to select one of multiple options later in the process.

Reference is now made to FIG. 4 which shows the relationship between code, D2C contract, and the UI interface within system 100. In this scenario the general code editor displays TypeScript/JavaScript code snippets showing interface definitions and exports, representing the underlying structure and functionality of the D2C components. The D2C contract contains configuration options and serves as a bridge between the code and the visual design. The UI design shows a product page for “Drawstring Linen Pants” priced at $95.00 and illustrates the visual implementation of the product, including product images, color selection options, and UI elements like buttons.

Examples of a D2C contract content may include what data should be provided to the UI and what the specific building block the D2C contract should expect to find in the design. The expected blocks may correspond to D2C components which may use their specific APIs for events, interactions, animations, validations, or any other need. Animations may present a flow that is temporal, for example, the animation may start with an event on one design variant and after several seconds end with a different design variant which may be relevant to the D2C component.

It will be appreciated that there may be different types of D2C contracts such as project contracts created for a specific project which all the addition of functionality to an application or site, library contracts which may be ready made templates to be used and special contracts which may display (for example) responsive breakpoints, SEO, multiple languages, accessibility, A/B testing, BI reporting etc.

As discussed herein above, the aspect (or subcontracts contracts) are additional contracts that may define specific functionalities or features to be implemented in the UI design. These contracts extend the capabilities of system 100 by allowing designers to incorporate advanced features directly into their designs without requiring developer intervention. Some key types of aspect contracts may include:

Business Intelligence (BI) events which may allow designers to select UI elements that, when interacted with, trigger BI events for data collection and analysis.

Multilingual support enabling designers to specify translation keys for text and image elements, facilitating easy localization of the interface. The designer may enter translation keys for test and image elements (and potentially other elements) to translate those elements to different languages. The actual method of translation is up to the D2C component associated with the multilingual contract.

A/B testing to permit designers to create multiple variants of a design and define rules for selecting which variant to display based on user groups or other criteria and auto-testing kits. The results may provide UI designers with tools to define interaction flows for developers to create UI designs for automated testing of the user interface design via UI design tester 53 described in more detail herein below.

An aspect contract may further define responsive breakpoints to create different UI designs for different devices or any accessibility (ally) limitations.

The aspect contracts may empower designers to implement complex functionalities that would typically require developer involvement, by streamlining the design-to-implementation process and reducing the need for back-and-forth between design and development teams.

A typical workflow for system 100 may be a custom development flow. In this scenario, the UI designer may use design editor 41 to design his UI. It will be appreciated that the UI designer may use a catalog of pre-defined front-end components as stored in repository 80 such as e-com, booking and events. Contract fulfiller 42 may then load any associated D2C contracts from repository 80 to make it live in order to restrict or guide the UI designer in his use of the components accordingly. Once the UI design is finished, it may be published by publisher 43. In an alternative embodiment, publisher 43 may be a standalone element outside of D2C tool 40.

It will be appreciated that an initial D2C contract may be created through a collaborative process involving both developers and UI designers. It will be further appreciated that an initial UI design need not be complete in order to create a contract which may be based on initial intent only (i.e., an interactive element is specified but not the type (button, radio etc.) In this scenario, the initial created wireframe may comprise tags with intent to update at a later stage.

As discussed herein above, contract handler 60 may comprise a contract creator 61, a contract editor 62, a contract updater 63 and an AI contract verifier 64.

D2C contracts may be created from scratch by the developer after receiving the initial UI using contract creator 61, by editing an existing design or by using a standard pre-defined template which may be retrieved from repository 80. D2C contracts may also be created completely or partially with the help of LLM coordinator 70 to create contracts out of “rough sketches” or incomplete designs as described in more detail hereinbelow. The developer may then create the D2C contract accordingly which is then associated with the pertinent front-end components and saved in repository 80. Once a D2C contract has been created, it may be edited by both designer and developer using contract editor 62. It will be appreciated that there is a multi-stage flow to creating a D2C contract-intent, create, close, and publish. It will also be appreciated that D2C contracts may be created through a multi-stage flow, including intent, creation, closure, and publication stages to gradual refinement and agreement between designers and developers.

Contract updater 63 may ensure that when a UI design is updated, all derived designs using the same D2C contract are updated as well.

AI contract verifier 64 may verify a finished contract by ensuring compatibility with the user interface design with the pertinent D2C components both manually and/or automatically. It may verify whether that all required components are present to ensure that required functionality can be enabled.

AI contract verifier 64 may be an AI agent designed to ensure compatibility between user interface designs and D2C components, while also detecting contract violations. It may undergo a comprehensive training process utilizing a diverse dataset that encompasses existing D2C contracts and their implementations, correct and incorrect examples of UI designs and their compatibility with D2C components, historical data on design changes that have broken D2C contracts, and annotated design documents and code snippets highlighting critical compatibility points.

The training methodology for AI contract verifier 64 may incorporate multiple machine learning techniques and employ supervised learning to recognize patterns of compatibility and contract adherence from labeled examples. Unsupervised learning is also utilized to identify underlying structures and relationships within design and contract data. Additionally, reinforcement learning is applied to enhance any decision-making processes for flagging potential issues. The knowledge base for AI contract verifier 64 may be continuously updated through ongoing learning, incorporating new examples and feedback from designers and developers. It undergoes fine-tuning on domain-specific data related to UI/UX design principles, software development practices, and D2C integration workflows, enabling it to understand and interpret various design file formats, code structures, and contract specifications for comprehensive compatibility checks.

In terms of output, AI contract verifier 64 may generate a range of valuable information. It may tag elements according to the pertinent D2C contract in order to produce a detailed compatibility report that analyzes the alignment between the user interface design and D2C contract specifications. This report may include a list of compliant design elements, identify missing required components, and offer suggestions for resolving any incompatibilities. AI contract verifier 64 may also provide immediate contract violation alerts, notifying designers or developers when a design change breaks a D2C contract. These alerts may include specific details of the violation, the affected contract clause or component, potential impact on functionality, and suggested remediation steps.

For automated verification processes, AI contract verifier 64 may deliver pass/fail statuses for each contract requirement, along with confidence scores for its assessments and identification of areas that may require manual review. It also may generate design optimization suggestions, recommending alternative design patterns that better fit the contract or modifications to enhance functionality within contract constraints. When recurring issues arise, AI contract verifier 64 may propose updates to the D2C contract, suggesting modifications to better accommodate design needs or new clauses to address emerging design patterns or technologies.

Over time, AI contract verifier 64 may also conduct trend analysis, providing insights on common compatibility issues across projects, frequently broken contract clauses, and design patterns that consistently adhere to or violate contracts. Furthermore, it may generate data on its own performance, including accuracy rates of its verifications, false positive/negative rates, and areas where it requires additional training or human oversight.

As discussed herein above, both D2C tool 40 and D2C fulfilling IDE 50 may comprise contract fulfillers 42 and 52 to ensure that any terms and conditions pertinent to the D2C contract are met both during design and any updates to the code. Contract fulfillers 42 and 52 may check that the pertinent D2C component has a public contract and the means to extract it. The D2C components may provide contracts which have multiple types and attributes as discussed herein above. For example, D2C components may provide only public contracts, or contracts which have attributes specifying to which type of front-end components they are exposed.

System 100 may also support relevant plug-ins (or may have the functionality built into it) to support relevant D2C contract import.

It will be appreciated that the D2C contracts may be used to create design stories. A design story is one realization of a D2C contract which can provide data and interactive elements which lead to a next story instance. Multiple stories may be linked this way to form a timeline, or a story line which may be converted to a UI design. Stories are structured narratives or scenarios that describe how a user interface should function and interact with the D2C components. These stories serve as a bridge between design specifications and functional implementation, guiding the creation of UI designs and ensuring alignment with the D2C contract. An example is an e-shop which may lead an end-user from a home page to an e-store, to a particular product, to a cart (once the product has been selected). An embodiment of system 100 may also include procedural, declarative, or other languages to specify the progression and order of design stories.

The “next story” may indicate the same D2C component using a different story. D2C tool 40 may use the set of D2C components and “next story” indication for UI design creation for each story.

Reference is now made to FIGS. 5A. 5B and 5C which illustrate an exemplary design story. FIGS. 5A. 5B and 5C show a project structure for “rnd.apparel” with different contract components (Home, Product, Cart,) on the left and a product listing page on the right. These represent the starting point of a design story, showing how the overall project is structured.

FIG. 5A starts the design story showing the home page of the store. FIG. 5B continues the story by showing the product page design for “Drawstring Linen Pants”, demonstrating how individual product contracts are implemented visually. FIG. 5C shows the cart or checkout interface.

In another example, for a form design, the design story may have different content in the form fields. In addition, the design story may include, for interactive elements, a link to a next design story, creating a story line or a UI design. With the form example, the submit button is an interactive element, for which the next story may be showing the form after posting the content. The design tool may use designs associated with the D2C contract to create derived design examples for each story.

For example, with the form example above, D2C tool 40 may take as input X design stories and copy the main design Y times, injecting the content from the stories.

Contract editor 62 may allow designers to modify or add new design stories as needed.

It will also be appreciated that design stories may also be used to generate tests for D2C components, as they capture D2C output and test cases. It will be appreciated that each step in a design story may include an expectation (or baseline) from the code being evaluated from its interaction with the relevant D2C contract. This expectation may include the dynamic tags data and interactions from interactive tags. This data may be used to generate a test as to what is expected to happen for a particular action. For example, for an interactive element, there is already an expectation (or baseline) as to what should the dynamic and variant elements should be. It will be further appreciated that expectations are part of the D2C contract which can be considered the enabler by specifying both the action (if it happens) and the expectation (what should happen). D2C component tester 65 may use this baseline to determine if the pertinent D2C component is behaving as defined by its D2C contract. If not, D2C component tester 65 may flag or alert the developer accordingly.

Once the D2C contracts have been verified by AI contract verifier 64, the developer may use them to create UI designs for an application.

LLM coordinator 70 (via relevant prompts to LLM 200 as described in more detail herein below) may check if there are missing design stories which may imply cases not considered by the design or D2C contracts and may generate missing stories. Examples are empty states, error states, long content, and long list cases.

A UI design containing a first D2C component may activate a set of interactions via its associated D2C contract to move to second D2C component using the same story (matched by name or ID, as an example).

It will be appreciated that a D2C component may comprise an associated auto-test feature or kit. This may be implemented as a plugin to D2C tool 40 and may define flows between multiple examples of the same D2C component and examples of different components according to associated D2C contracts.

System 100 may also enable the creation of working UIs. An example is product page, cart, checkout, and payment for an e-com flow of components. Another example could be a working UI from a single product, no product, or many products. As discussed herein above, a design story may be used to verify the design and create UI design.

As discussed herein above, LLM coordinator 70 may provide artificial intelligence support for different aspects of system 100 via LLM 200, such as assisting in the creation and updating of D2C contracts, creating full contracts from “rough sketches” or incomplete designs according to user intent facilitating contract creation from various starting points LLM coordinator 70 may further providing suggestion and recommendations for UI design improvements based on contract specifications, generating code snippets that align with both design requirements and contract specifications, offering real-time assistance to designers and developers during the implementation process and automating the generation of design stories and test cases based on D2C contracts.

As discussed herein above, LLM coordinator 70 may provide support for different elements of system 100 by preparing prompts for LLM 200. As discussed herein above, LLM 200 may be a known Large Language Model (LLM) 200 such as ChatGpt (from Open AI) but may also use different technologies-generative or otherwise. It will be appreciated that LLM coordinator 70 may use hard coded prompts or templated prompts and may also use LLM 200 to create prompts utilizing coding assistants known in the art (such as those described in https://www.qodo.ai/blog/best-ai-coding-assistant-tools. It may also use MCP (Model Context Protocol) context to instruct LLM 200 from its knowledge of the internal workings of system 100. It will be appreciated that LLM 200 may update itself in real time after every interaction with LLM coordinator 70 which may remember the context from one session to another depending on the LLM used. Different types of LLM may include off the shelf LLMs, fine-tuned LLM's and Retrieval-Augmented Generation (RAG) LLMs.

Off-the-shelf LLMs are pre-trained, general-purpose language models that can be used without modification. They offer broad knowledge and capabilities but may lack domain-specific expertise. LLM coordinator 70 may use these for general tasks or as a starting point for more specialized applications.

Fine-tuned LLMs are models that typically start with an off-the-shelf LLM that may be further trained on domain-specific data relevant to D2C processes, software development, and UI/UX design. Fine-tuning allows the model to develop more accurate and relevant responses within the context of system 100.

Retrieval-Augmented Generation (RAG) LLMs combine the broad knowledge of pre-trained language models with the ability to retrieve and incorporate specific, up-to-date information from a curated knowledge base. In the context of system 100, RAG may be used to access current project documentation, design guidelines, and code repositories, ensuring that the LLM's outputs are always aligned with the latest project specifications and best practices.

Reference is now made to FIG. 6 which illustrates the elements of LLM coordinator 70. LLM coordinator 70 may comprise a prompt generator 71, an LLM interaction manager 72, an AI output evaluator 73, an integration module 74 and an AI learning optimizer 75. Prompt generator 71 may comprise an AI context analyzer 711, prompt retriever 712 and AI content gap filler 713. AI learning optimizer 75 may further comprise a prompt enhancer 751, a prompt creator 752 and a content element adjuster 753.

It will be appreciated that LLM coordinator 70 may operate through several stages to provide intelligent assistance for system 100. Prompt generator 71 may create an appropriate prompt for LLM 200 by retrieving a prompt template according to the pertinent project and ensuring that relevant fields are filled in correctly.

AI context analyzer 711 may analyze the current state of a pertinent D2C project. Prompt retriever 712 may select an appropriate prompt template based on the context and task. AI content gap filler 713 may identify and fill in any missing information required for the retrieved prompt. LLM interaction manager 72 may send the completed prompt to LLM 200. AI output evaluator 73 may assess LLM 200's response for relevance, accuracy, and adherence to D2C contract specifications and integration module 76 may incorporate satisfactory outputs into the appropriate part of system 100.

AI learning optimizer 77 may update the knowledge base of system 100 and refine prompting strategies based on successful interactions and user feedback.

AI context analyzer 711 may analyze the current state of the pertinent D2C project, including existing D2C contracts, user interface designs, and code components. It may consider factors such as project type, design patterns, and development stage to provide a structured representation of the project state. It will be appreciated that AI context analyzer 711 may be considered a specialized AI agent trained using a combination of supervised learning on labeled D2C project datasets and unsupervised learning on large corpora of software development projects, UI/UX designs, and general D2C contracts. The training process may involve exposure to diverse D2C projects at various stages of development, learning to identify key components, understanding relationships between different project elements, and recognizing patterns in project evolution and common development workflows.

AI context analyzer 711 may provide as its output a hierarchical breakdown of existing D2C components and their relationships, an assessment of the completeness and consistency of current D2C contracts, identification of any misalignments between UI designs and implemented code, a summary of the project's development stage and critical areas requiring attention, and metadata about the project type, design patterns in use, and relevant technological stack.

Prompt retriever 712 may select appropriate prompt templates from repository 80 based on the context and specific task at hand as determined by AI context analyzer 711. It may use hard-coded, templated, or dynamically generated prompts as needed.

AI Content gap filler 713 may also be a specialized AI agent and may identify missing information required for the retrieved prompt and fill these gaps using project-specific data, user inputs, or previously generated content retrieved from repository 80. This may ensure that prompts are comprehensive and tailored to the specific needs of the pertinent D2C project.

AI Content gap filler 713 may undergo a training process that leverages a diverse and comprehensive dataset which may include historical D2C project data, completed prompts and their outcomes, user input patterns and preferences, project-specific data structures and schemas, previously generated content for similar projects, and mappings between prompt templates and required information types.

The training methodology for AI content gap filler 713 may incorporate a variety of advanced machine learning techniques. It also may employ Natural Language Processing (NLP) to comprehend and analyze prompt structures, pattern recognition to identify common information gaps in prompts, and contextual understanding to determine relevant project-specific data. AI Content gap filler 713 may also utilize sequence-to-sequence learning for generating appropriate filler content. AI Content gap filler 713 may also engage in continuous learning, constantly updating its knowledge base with each new project and user interaction. It is fine-tuned on domain-specific terminology and concepts related to D2C projects, UI/UX design, and software development, ensuring its outputs are highly relevant and accurate.

AI Content gap filler 713 may produce a range of outputs to support D2C projects. Its primary output is a fully populated prompt with all identified gaps filled, including the original prompt template with inserted information and metadata indicating the source of each filled gap. AI Content gap filler 713 may also generate an information source report, detailing where each piece of gap-filling information was sourced, including references to specific project documents, timestamps of relevant user inputs, and identifiers for any previously generated content used. For each piece of filled information, AI Content gap filler 713 provides confidence scores indicating its certainty in the appropriateness of the filled content, along with alternatives for low-confidence fill ins to allow for human review if necessary.

When critical information cannot be filled automatically, AI Content gap filler 713 may generate specific queries for additional user input and suggestions for potential sources of the required information within the project ecosystem. AI Content gap filler 713 may also provide additional context or explanations for the filled information, as well as references to related project elements that may be relevant. Based on the project context (as determined by AI context analyzer 711), AI Content gap filler 713 may offer recommendations for additional prompt elements that could enhance output quality, or variations of the prompt that might yield more comprehensive results. Finally, AI Content gap filler 713 may generate data on its own performance, including success rates of gap-filling in terms of user acceptance and output quality, identification of recurring information gaps that might indicate a need for prompt template updates, and patterns in information sources that are most frequently useful for specific project types.

LLM interaction manager 72 may manage communication with LLM 200 sending completed prompts and handling multiple API calls for complex tasks.

AI output evaluator 73 may be an AI agent that assesses LLM 200 responses for relevance, accuracy, and (for example) adherence to D2C contract specifications. It may be trained specifically for assessing LLM outputs in the context of D2C contracts and associated software development.

AI output evaluator 73 may be an AI agent trained on a diverse dataset comprising existing D2C contracts and their associated implementations, correct and incorrect examples of LLM 200 outputs for various D2C tasks, annotated design documents and code snippets, and user feedback and corrections from previous D2C projects. It may undergo supervised learning, reinforcement learning, domain-specific fine-tuning, and continuous learning to enhance its evaluation capabilities.

AI output evaluator 73 may produce a structured assessment of LLM 200's output including:

A relevance score: a numerical score indicating how well the output addresses the specific D2C task or query.

An accuracy evaluation: an analysis of factual correctness and logical consistency within the context of software development and D2C principles.

Contract adherence metrics: detailed metrics on how well the output aligns with the specified D2C contract requirements, including data structures, event handling, and design specifications.

Issue Identification: a list of potential problems or inconsistencies in the LLM 200 output, categorized by severity and type.

Improvement suggestions: specific recommendations for refining LLM 200 output to better meet D2C contract specifications and project requirements.

Confidence Level: an indicator of AI output evaluator 73's certainty in its assessment, helping to identify cases where human review may be necessary.

Pass/fail decision: a binary decision on whether the LLM 200 output meets the minimum quality threshold for integration into the D2C workflow.

Based on some or all of these metrics, AI output evaluator 73 may determine that the output is suitable for use by system 100 if not, it may instruct AI context analyzer 711 to restart the pertinent task.

Integration module 74 may incorporate satisfactory LLM 200 outputs into the appropriate parts of the system 100, such as checking fulfillment, creating and updating contracts, suggesting design modifications, or providing code snippets as discussed herein above.

AI learning optimizer 75 may be another dedicated AI agent to analyze interactions, outcomes, and feedback to refine system 100's overall performance over time. It is designed to improve system 100 performance continuously.

AI learning optimizer 75 may collect data from interactions between LLM coordinator 70 and LLM 200 for a D2C project, including the initial context, prompts used, LLM 200 responses, and any subsequent refinements or iterations. It also gathers user feedback, such as acceptance or rejection of suggestions, manual edits made to AI-generated content, and explicit ratings or comments provided by users.

AI learning optimizer 75 may pre-process the data to identify patterns, correlations between prompt structures and successful outcomes, and common areas of improvement. It may then use this pre-processed data to train on various aspects, including prompt effectiveness, context relevance, output quality, and user satisfaction metrics.

AI learning optimizer 75 may produce several outputs to enhance the performance of LLM coordinator 70.

Prompt enhancer 751 may create refined versions of existing prompts in repository 80. Prompt creator 752 may create entirely new templates for prompt generator use that have shown higher success rates in generating desired outputs. The new and updated prompt templates may be saved in repository 80.

Content element adjuster 753 may adjust how different contextual elements are prioritized when formulating prompts or evaluating outputs.

AI learning optimizer 75 may also provide improved criteria for assessing the relevance and accuracy of LLM-generated content in the context of D2C contracts and designs with suggestions for modifying the sequence of steps in the general operation of LLM coordinator 70's operation to improve efficiency and user experience.

AI learning optimizer 75 may also use user-specific or project-specific settings that tailor the prompt generator's behavior to individual preferences or requirements and provide recommendations for additions or modifications to the system 100's core knowledge base, ensuring it remains up-to-date with evolving best practices in D2C integration.

Finally, AI learning optimizer 75 may refine rules for choosing between different types of LLMs based on task characteristics and historical performance.

All recommendations may be implemented automatically or presented to designers and developers via their appropriate client for viewing and updating.

It will be appreciated that LLM coordinator 70 may use machine learning frameworks and natural language processing libraries to implement its AI agents. The exact technical specifications may vary based on the specific implementation and requirements of system 100.

As discussed herein above, LLM coordinator 70 may provide contract creator 61 content for a D2C contract by providing language based on textual descriptions, design notes and drawings. It may further provide stubs for code for D2C components specifying intent only as described herein above. LLM coordinator 70 may may function “inside out” and take an existing D2C contract and create a suggested design and associated code accordingly. It may also function “outside-in” by taking disparate designs and code and suggesting an associated D2C contract. In this scenario, LLM coordinator 70 may further make recommendations to changes to both the design and the code (via D2C tool 40 and D2C fulfilling IDE 50) to comply with the pertinent D2C contract.

LLM coordinator 70 may further provide editing assistance to both D2C tool 40 and D2C fulfilling IDE 50 by indicating any deviations from the D2C contract, providing corrective steps, and suggesting a next stage (if only partial implementation is available).

It will be appreciated that in addition to the interaction with design elements, D2C contract may be approached and utilized by non-design elements within the software development ecosystem. These non-design elements may include, but are not limited to, testing frameworks, analytics tools, and third-party integrations.

D2C design tester 53 may harness analytics tools (such as Usermaven.com commercially available from Usermaven.Inc and userpilot commercially available from userpilot.com) which may be configured to receive and process events from a D2C component, enabling the collection of data on how the component is used within an application. This data can be invaluable for understanding user behavior and improving effectiveness of the D2C component.

TPA integrator 90 may interface with third party applications or other external services to the current design such as payment gateways or social media platforms and may allow interaction with a D2C component to extend its functionality. Other external services may include web services,

APIs, serial peripheral interfaces (SPIs), external AI modules and agents and any other integration technologies. These integrations may utilize the D2C contract to ensure proper communication and data exchange between the D2C component and the external services.

Thus, design to code system 100 may guide designers and developers in creating UI designs based on a D2C contract, generating design stories and general UI designs constrained by the contracts. It streamlines the design-to-code workflow, enhances collaboration between designers and developers, and reduces the time and effort required to bring a design concept to fruition in software development. It bridges the gap between UI design and functional implementation by allowing designers to work directly with D2C components within their design environment.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A design to code (D2C) system for component integration in software development, comprising:
at least one processor;
a design to code (D2C) tool running on said processor configured to enable creation of D2C projects comprising user interface designs based on D2C components having associated D2C contracts, wherein said D2C contracts comprise at least instructions for D2C component data, interactive elements and at least one aspect contract for said D2C components specifying requirements for said user interface designs; and
a D2C contract handler running on said at least one processor configured to create and manage said D2C contracts.

2. The system of claim 1 and further comprising a contract fulfilling integrated development environment (IDE) configured to enable development of code for said D2C components in accordance with said D2C contracts.

3. The system of claim 2, wherein said D2C tool further comprises:
a design editor configured to enable creation of said user interface designs;
a contract fulfiller configured to verify compatibility of said user interface designs with said D2C contracts; and
a publisher configured to publish finalized user interface designs.

4. The system of claim 3, wherein said D2C contract handler further comprises:
a contract creator configured to create new D2C contracts;
a contract editor configured to enable editing of existing D2C contracts;
a contract updater configured to update derived designs when a base design is modified;
a contract verifier configured to verify compatibility between user interface designs and associated D2C components; and
a D2C component tester to determine if a D2C component is behaving as defined by its D2C contract.

5. The system of claim 4, further comprising a large language model (LLM) coordinator in communication with a large language model (LLM) configured to:
generate content for D2C contracts according to at least one of: textual descriptions, design notes, and drawings;
provide suggestions for user interface designs and design stories based on existing D2C contracts; and
provide editing assistance for said D2C tool and said contract fulfilling IDE.

6. The system of claim 5, wherein said at least one aspect contract consists of provisions for at least one of: business intelligence events, multilingual support, A/B testing, accessibility limitations, and responsive breakpoints.

7. The system of claim 6, further comprising a third-party application integrator configured to interface with external services to said D2C system and extend functionality of said D2C components to said external services in accordance with said D2C contracts.

8. The system of claim 1, wherein said D2C contracts further comprise instructions to:
generate design stories, wherein said design stories describe how a user interface should function and interact with said D2C components;
create derived design examples for a design story by copying a main design and injecting content from said design stories; and
use said design stories to generate tests for said D2C components by capturing D2C component output and test case.

9. The system of claim 5, further comprising at least one repository configured to store at least one of data types, front-end components, back-end components, D2C contracts, aspect contracts, contract templates, prompt templates and knowledge base data.

10. The system of claim 9, wherein said LLM coordinator comprises:
a prompt generator configured to analyze a current state of a D2C project, select a prompt template accordingly and to fill in missing information required for said prompt template;
an AI (artificial intelligence) output evaluator configured to assess a response from said LLM for relevance, accuracy, and adherence to D2C contract specifications; and
an AI (artificial intelligence) learning optimizer to analyze interactions, outcomes, and feedback with said LLM to refine system performance of said D2C system over time.

11. A computer-implemented method for a design to code (D2C) system for component integration in software development, comprising:
enabling creation of D2C projects comprising user interface designs based on D2C components having associated D2C contracts using at least one processor, wherein said D2C contracts comprise instructions for at least D2C component data, interactive elements and at least one aspect contract for said D2C components specifying requirements for said user interface designs; and
creating and managing said D2C contracts.

12. The method of claim 11, further comprising enabling development of code for said D2C components in accordance with said D2C contracts within an integrated development environment.

13. The method of claim 12, further comprising:
enabling creation of user interface designs via a design editor;
verifying compatibility of said user interface designs with said D2C contracts; and
publishing finalized user interface designs.

14. The method of claim 13, further comprising:
creating new D2C contracts;
enabling editing of existing D2C contracts;
updating derived designs automatically when a base design is modified;
verifying compatibility between user interface designs and associated D2C components; and determining if a D2C component is behaving as defined by its D2C contract.

15. The method of claim 14, further comprising:
prompting a large language model (LLM) to:
generate content for D2C contracts according to at least one of: textual descriptions, design notes, and drawings;
provide suggestions for user interface designs based on existing D2C contracts; and
provide editing assistance for design and contract fulfillment.

16. The method of claim 15, wherein said at least one aspect contract consists of at least one of:
business intelligence events, multilingual support, A/B testing, accessibility limitations, and responsive breakpoints.

17. The method of claim 16, further comprising interfacing with external services to said D2C system and extending functionality of said D2C components in accordance with said D2C contracts.

18. The method of claim 11, wherein said D2C contracts further enable:
generating design stories that describe how a user interface should function and interact with said D2C components;
creating derived design examples for a design story by copying a main design and injecting content from said design stories; and
generating tests for said D2C components by capturing D2C component output and test cases.

19. The method of claim 15, further comprising storing at least one of: data types, front-end components, back-end components, D2C contracts, aspect contracts, contract templates, prompts and knowledge base data in a repository.

20. The method of claim 19, wherein said prompting an LLM comprises:
analyzing a current state of a D2C project;
selecting a prompt template according to context and task as determined by said analyzing a current state;
identifying and filling in any missing information required for said prompt template;
assessing a response from said LLM for relevance, accuracy, and adherence to D2C contract specifications;
analyzing interactions, outcomes, and feedback with said LLM to refine system performance of said D2C system over time.
